(19) United States
(12) Patent Application Publication
(10) Pub. No.: US 2003/0088659 A1
(43) Pub. Date: May 8, 2003

(54) System and method for distributed state management

(76) Inventors: Hanumantha Rao Susarla, Bangalore (IN); Vikas Varma, Bangalore (IN); Venugopal Rao K., Karnataka (IN)

Correspondence Address: Robert C. Kowert, P.O. Box 398, Austin, TX, 78767-0398, US

(21) Appl. No.: 10/102,426

(22) Filed: Mar. 20, 2002

Related U.S. Application Data
(60) Provisional application No. 60/337,622, filed on Nov. 8, 2001.

(51) Int. Cl. G06F 15/173

(52) U.S. Cl. 709/223

(57) ABSTRACT

A framework for distributed state management across servers is described, in particular for enterprise systems. The framework provides an architecture including a distributed state management adapter for servers and their applications to access a distributed state management server. The distributed state management adapter is coupled to applications through an application program interface. The distributed state management server is couple to the distributed state management adapters through a standardized service provider interface. This framework enables interoperability among applications using state data. The distributed state management system may provide or support various functionalities, including state synchronization, secure data access, event notification, state management control, transaction based state management, and persistent state back-up.

### PRIORITY INFORMATION

This application claims benefit of priority to U.S. provisional application serial No. 60/337,622 filed Nov. 8, 2001 titled “Distributed State Management System Architecture”, which is hereby incorporated by reference in its entirety.

### BACKGROUND OF THE INVENTION

1. Field of the Invention

This invention relates to a distributed state management system, and in particular to component state interoperability of applications in distributed systems.

2. Description of Related Art

In networks, in particular over the Internet, systems that are part of the network, such as server computers, client computers, and other computing devices, interact by transmitting data between each other. In general terms, servers provide data for clients, and various computing devices can operate as either or both. In the past, servers operated using HTTP as their protocol. HTTP protocols did not enable servers to maintain much information besides logs regarding the details of communications with clients. Without the ability to accumulate information, it is difficult for servers to interact with or to distinguish between clients, users, or generally machines in the network, or their associated transactions.

Methods have been developed to enable data gathering and to keep track of data regarding sessions and their respective states, enabling interactions over networks that have become increasingly sophisticated. A session may include the record of at least part of the interactions between a client and a server or plurality of servers. A client's state may include data accumulated for a specific client during a session. Such data may include information concerning identification, preferences, requests, selections, or any data applicable or relevant to the client including data structures or temporary data. While a server may keep track of a client state, clients need not be aware of all the data composing the state. However, clients may influence or designate at least some of the data that forms its client state.

Web applications and other distributed applications have evolved into large-scale applications that demand more sophisticated computing services. Specialized application servers are desirable in order to provide a platform supporting these large-scale applications. For example, systems may function in several tiers, as illustrated in FIG. 1, from clients 101, through middle-tier systems 111 executing application servers 112 and applications 113, to back-end systems 121. Such systems, with the capability of using multiple cooperating middle-tier servers or other cooperating processes between clients and back-end systems, may be referred to as enterprise systems and may provide the basic infrastructure to host an enterprise application. Each server may include a state manager 114 for storing and retrieving state data. State managers 114 that are provided with identical application servers 112 (e.g. application servers from the same application server vendor) may provide interoperability for accessing state data, as illustrated at 150.

To share data and enable cooperation between multiple applications operating in intermediate tiers, synchronization, compatibility, and efficiency issues may need to be addressed. For example, applications that exchange or share state data may not execute on the same machine or share control of any physical storage devices. State data may be stored in one or more physical or virtual locations managed by a server. For example, Java 2 Enterprise Edition (J2EE) enables several means of storing a state. However, state management implementations are mostly server dependent. For example, Java 2 Enterprise Edition does not define a common standard for state management and each server may define its own scheme to obtain and maintain distributed state data. Each server owner, vendor, or third party may develop distinct methods and systems distributed state management for enterprise systems. The various configurations result in a lack of interoperability and complicates sharing data between different servers.

As illustrated in FIG. 2, clients 201 may be coupled to middle-tier systems 211 that execute different types of application servers 212. Such systems having different state mangers 214 (e.g. state managers provided by different application server vendors) may lack interoperability, as indicated at 250. Without interoperability, it may be difficult to implement various functions, such as high availability. Such system also lack a standardized interface for applications to manage state data. Maintaining high availability may involve providing redundant copies of data to enable recovery from a crash or other failure, thereby providing more reliable application and server functions, for example.

### SUMMARY OF THE INVENTION

A system and method are described to provide distributed management of client states across different servers in a network. An architecture for distributed state management including a distributed state management adapter (DSMA) and a distributed state management server (DSMS) defines standard interfaces to implement distributed state management. In one embodiment, various aspects of state management may be implemented, such as transaction based state management, secure data access, event notification, and state management control up to the level of class variables. In one embodiment, various features may be implemented, including persistent state backup or security features.

A distributed state management adapter provides an interface between an application, including an application server or any program generally, and a distributed state management server. An application may interact with state data managed by the distributed state management server through the standard interface of an associated distributed state management adapter. Distributed state management adapters may be implemented on different systems and respond to different applications that comply with the standard application program interface for the adapter. A distributed state management adapter may communicate with the distributed state management server through another standard interface in response to application interaction. The distributed state management server may provide distributed data management functionality such as maintaining state data availability and managing the life cycle of state data.

The distributed state management server may implement various functionalities, for example high availability. For example, the distributed state management server may implement fail-over recovery, load balancing, concurrent access of state data, and enable control for applications of the availability of state data. Transaction protocols may be supported using the present system and method, for example the X-Open standard.

A distributed data management system may include one or more application servers, one or more distributed state management adapters, and at least one distributed client state management server. Each of the distributed state management adapters may be coupled through a standard application program interface to one of the applications servers and each application servers may be configured to access state data from the distributed system. The distributed state management server, which may be configured to manage state data storage and retrieval, may be coupled to the distributed state management adapters through a standard service provider interface. The distributed state management adapters may be configured to communicate state data between corresponding application servers and the distributed state management server through the standard application program interface and the standard service provider interface.

A distributed state management adapter may include a standard application program interface and a standard distributed state management server interface. The standard application program interface may be coupled to an application server and the application server may access state data through the standard application program interface. The standard distributed state management server interface may be coupled to a distributed state management server and the distributed state management server may manage storage and retrieval of state data. The distributed state management adapter may be configured to communicate state data between the application server and the distributed state management server through the standard application program interface and the standard distributed state management server interface.

A distributed state management server may include a standard service provider interface and may be coupled to storage for storing state data. The standard service provider interface may be coupled to a plurality of distributed state management adapters configured to communicate through the standard service provider interface state data received through their standard application program interface. The distributed state management server may manage storage and retrieval of state data in the data storage.

### BRIEF DESCRIPTION OF THE SEVERAL VIEWS OF THE DRAWINGS

FIG. 1 illustrates a multi-tier system including state managers;

FIG. 2 illustrates non-interoperability between state managers in conventional systems employing different types of application servers;

FIG. 3 illustrates a distributed state management system including application servers, distributed state management adapters, and a distributed state management server, according to one embodiment.

FIG. 4 illustrates the registration of a distributed state management adapter with a distributed state management server, in one embodiment.

FIG. 5 illustrates the storage and access of state data from a distributed state management server by applications through distributed state management adapters, in one embodiment.

FIG. 6 illustrates transaction management, according to one embodiment.

FIG. 7 illustrates a distributed state management adapter, according to one embodiment.

FIG. 8 is a flowchart illustrating client state management on a distributed state management server through a distributed state management adapter, in one embodiment.

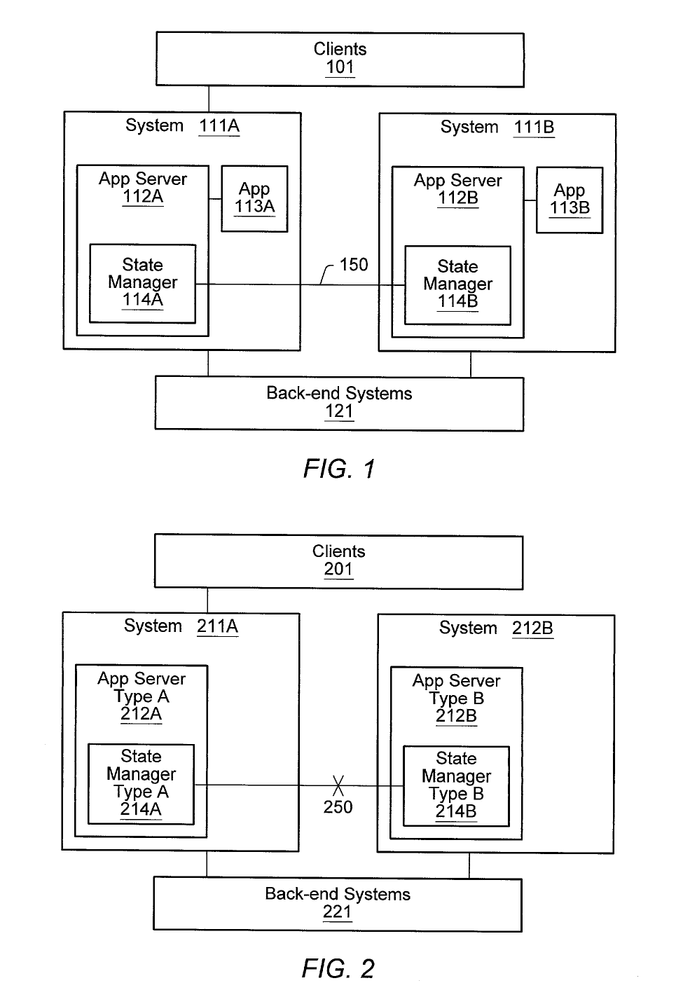

While the invention is described herein by way of example for several embodiments and illustrative drawings, those skilled in the art will recognize that the invention is not limited to the embodiments or drawings described. It should be understood that the drawings and detailed description are not intended to limit the invention to the particular form disclosed but, on the contrary, the intention is to cover all modifications, equivalents, and alternatives falling within the spirit and scope of the present invention as defined by the appended claims. The headings used are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS OF THE INVENTION

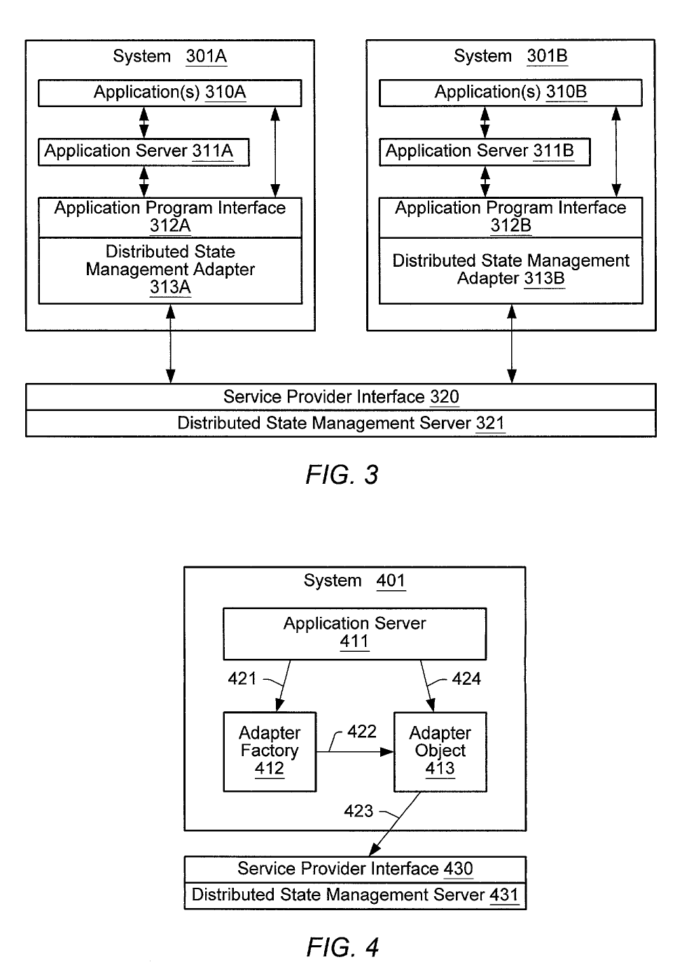

FIG. 3 illustrates systems 301 configured to share state data, according to one embodiment. The systems 301 may be part of a middle tier in a multi-tier enterprise system, for example. Systems 301 may be any type of computing device, such as a server computer, mainframe, desktop computer, workstation, etc. The systems 301 may include applications 310, application servers 311, and associated distributed state management adapters 313 each coupled to corresponding application servers 311 and applications 310 through an application program interface (API) 312. In one embodiment, a distributed state management adapter 313 may be coupled to an application server 311, to one or more applications 310, or both. One or more applications 310 may be coupled to an application server 311 and interact with a distributed state management adapter 313 through that application server 311 or directly through API 312. Distributed state management adapters 313 are coupled to a distributed state management server 321.

In one embodiment, a distributed state management adapter 313 may be a system-level software driver used by an application 310 and/or application server 311 for connecting to a distributed state management server 321. In one embodiment, a distributed state management adapter 313 may be used by an application 310 through a container or application server 311 to access the distributed state management server 321. Other methods of coupling distributed state management adapters between applications and a distributed state management server may be implemented. In one Java™ embodiment, a distributed state management adapter 313 and an application server 311 may be running in the same virtual machine, e.g. a Java Virtual Machine (JVM). The distributed state management adapter may operate as a driver to connect to the distributed state management server. The distributed state management server may run on a separate virtual machine. In one embodiment, applications may be any Java 2 Enterprise Edition™ application including Java 2 Enterprise Edition components such as servlets, statefull session beans, or any other java classes for which distributed state management is desired. Applications 310 may be any program using state data.

The distributed state management server 321 may perform various distributed state management functions, such as managing the replication and life cycle of state data or state objects. The distributed state management server may manage concurrent access, updating, and invalidation of state data. The distributed state management server may be configured to provide high state data availability. It may include mechanisms for fault tolerance, persistence, and security. In one embodiment, the distributed state management server may be transparent to the applications interacting with distributed state management adapters. Thus, adapter 313 may provide an abstraction of state management server 321 to applications.

Distributed state management adapter 313 may be configured to provide a standard interface to applications 310 and/or application servers 311 for functionality relating to distributed state management server 321. However, the implementations of distributed state management adapter 313A and distributed state management adapter 313B may be different, as long as the standard application program interface is provided and an the adapter follows the standard service provider interface to the distributed state management server 321. Applications 310 and application servers 311 may use the standard interface defined by the application program interface 312 to access distributed state management functionality provided by distributed state management server 321. Applications 310 that do not support the standard application program interface 312 may still access state management functionality through an application server 311 that does support API 312.

Distributed state management adapters 313 interface to the distributed state management server 321 according to a service provider interface 320. For example, a distributed state management adapter 313A may receive client state data requests, such as storage or retrieval requests, for applications 310A or application servers 311A through application program interface 312A. The distributed state management adapter 313A may then transmit to distributed state management server 321 the client state data requests through the service provider interface 320. Distributed state management server 321 may return client state data or manipulate some data structure including client state data in response to the client state data requests received from distributed state management adapter 313A.

The use of distributed state management adapters 313 may provide for interoperability for state data between different application servers and applications. By creating a standard abstraction for distributed state data management, distributed state management adapters 313 may allow applications servers and applications from different sources to share their state data. For example, application servers from different vendors that otherwise lack interoperability for state data management, may participate together in a distributed state management system through distributed state management adapters 313. As long as each application server conforms to the standard application program interface 312, then application servers from different vendors may participate in the same distributed system. For example, an HTTP session could be distributed across application servers from two different vendors that each include a distributed state management adapters 313. Similarly, applications created by different developers may interoperate for state data management through distributed state management adapters 313 if they conform to the standard API 312.

Also, since distributed state management adapters 313 interface to the distributed state management server 321 according to a standard service provider interface 320, any distributed state management server 321 that implements service provider interface 320 may provide state management functionality to any applications having a distributed state management adapter 313. Thus, distributed state management adapters 313 may provide for interoperability for state management between application servers, applications, and a distributed state management server. Distributed state management adapters 313 provide a standardized abstraction layer for state data management between components of a distributed system.

FIG. 4 illustrates the deployment of a distributed state management adapter 413 and its registration with a distributed state management server 431. Applications or applications servers managing accessing state data across servers may use the functionalities provided by a distributed state management server through a distributed state management adapter. An application server 411 executing on a system 401 may load a distributed state management adapter to realize this architecture. Application server 411 may load, execute, or otherwise invoke an adapter factory, as indicated at 421. The adapter factory 412 may identify and load a distributed state management adapter 413, as indicated at 422. In one embodiment, the adapter factory may be a singleton class and the application server may load the distributed state management adapter as an object through the adapter factory class.

Once created, the distributed state management adapter 413 may register with the distributed state management server 431 through the service provider interface 430, as indicated at 423. The registration may indicate various characteristics of the distributed state management adapter 413, for example details about its configuration, the system 401, the application server 411, or any information that would facilitate or enable functionalities of the distributed state management system that may be implemented.

After registering with the distributed state management server 431, the distributed state management adapter 413 may indicate its readiness to function to the application server 411, as indicated at 424. The distributed state management adapter may function as an integral part of the application server 411 or may operate as a distinct process within system 401. In one embodiment, the distributed state management adapter is an object that is returned by the adapter factory 412 to the application server 411 after the distributed state management adapter has registered with the distributed state management server 431.

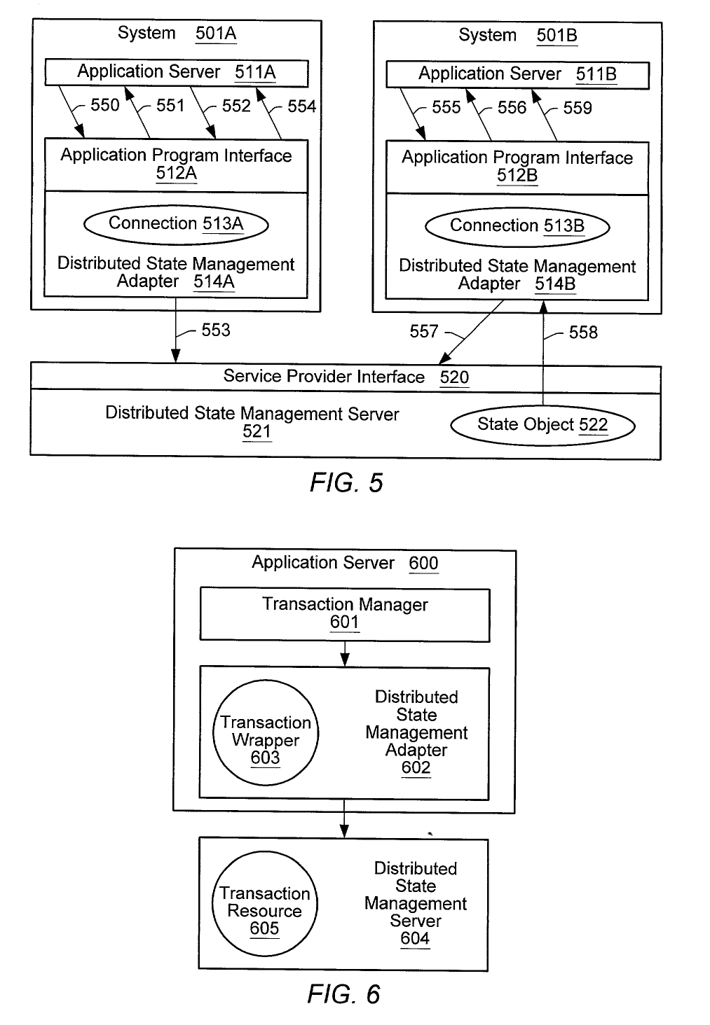

FIG. 5 illustrates the operation of one embodiment of the present invention during the storage and retrieval by servers or systems 501 of state data stored as state object 522 by a distributed state management server 521. Each system 501 includes an application server 511 coupled to a distributed state management adapter 514 through an application program interface 512. The distributed state management adapters may manage their connection to their respective application servers 511 using connection structures or objects 513.

A connection object 513 may provide functions for handling transactions and for managing state data. Some of the functionalities that may be provided include: a create function to create new distributed state object, a sync function to synchronize a state object, a retrieve function to retrieve a particular state object, an invalidation function to remove and/or invalidate a state object, and a relocate function to give control over a state object to a different application server or container. In one embodiment, a standard event notification mechanism may be used from the distributed state management server side to the application server for state object invalidation, server failure, object relocation, or other functions.

As shown in FIG. 5, application server 511A may invoke its distributed state management adapter 514A to establish a connection, as indicated at 550, through the application program interface 512A. The distributed state management adapter 514A may create or initialize connection 513A for application server 511A. Distributed state management adapter 514A may return a connection object 513A or otherwise provide application server 511A methods or functions for interacting with the distributed state management server, as indicated at 551. Application server 511A may invoke a create function of the connection object 513A through the application program interface 512A of distributed state management adapter 514A to create a state object. For example, the application server may create a state object to store session information, such as Httpsession information.

A distributed state management adapter 514A may generate a universal identifier corresponding to the state object to be created for application server 511A. The universal identifier may be a system wide unique identification attached to state objects. Distributed state management server 521 may use a universal identifier operations to access or store state objects. The universal identifier may include data corresponding to the application server 511A or to the distributed state management adapter 514A, may refer to a session identification (such as an HttpSession Id), or otherwise ensure that the number generated is unique. In one embodiment the distributed state management server 521 generates universal identifications. The distributed state management adapter 514A may return the universal identification to the application server 511A, as indicated at 554. In one embodiment, the distributed state management adapter 514A may return the universal identifier at a later time, for example after receiving some confirmation from the distributed state management server 521 that the state data was stored as requested.

The distributed state management adapter may then invoke a create function of the distributed state management server 521 through the corresponding service provider interface 520, as indicated at 553. The distributed state management adapter 514A may pass the universal identifier and state information for the state object to be created to the distributed state management server 521 through the service provider interface 520. In one embodiment the universal identifier and state information are passed as part of invoking the create function, as indicated at 553. The distributed state management server 521 may store the session information or data received as state object 522. The distributed state management server 521 may create or update data structures containing data relating to state objects or data stored by distributed state management server 521. Distributed state management adapter 514A may return the universal identifier for the created state object to the application server, as indicated by 554. The distributed state management adapter 514A may also cache the state object within its data storage space.

Application server 511B may invoke a retrieve function of its connection 513B of distributed state management adapter 514B through application program interface 512B, as indicated at 555. A universal identifier may be included or transmitted with the retrieve invocation to identify the state object to be retrieved. The distributed state management adapter 514B may check its local storage space to determine if the requested object is cached. If distributed state management adapter 514B has the requested object cached, it may return the object or information from the object to the application server 511B, as indicated at 556. Otherwise, distributed state management adapter 514B may invoke a retrieve function for the requested object from the distributed state management server 521 through service provider interface 520, as indicated at 557. The distributed state management adapter 514B indicates the universal identifier corresponding to the requested object. The distributed state management server 521 may access and return state object 522 corresponding to the requested object, as indicated at 558; for example, using the universal identification as a reference against data structures. Upon receiving the requested object from the distributed state management server 521, the distributed state management adapter 514B may cache that data locally. The distributed state management adapter 514B may return the information requested to the application server 511, as indicated at 559.

In one embodiment, the underlying communication protocol between a distributed state management server and a distributed state management adapter may be Remote Method Invocation over Internet Inter-ORB Protocol (RMI/IIOP). Secure Sockets Layer (SSL) support may be provided. The RMI/IIOP may be implemented as a standard for communication between distributed state management server and distributed state management adapters. In other embodiments, other protocols may be implemented as a standard protocol for communication. Multiple protocols, including RMI/IIOP may be supported by a distributed state management server or distributed state management adapters. A particular protocol may be the default protocol. In some embodiments, different distributed state management adapters may use different protocols from each other and a distributed state management server may support the different protocols in accordance with the service provider interface.

In one embodiment, functions providing transaction processing may be implemented by a connection object, or a distributed state management server generally, as illustrated in FIG. 6. In particular, distributed transaction processing may follow the standard XA interface based on the X/Open CAE Specification. The XA interface defines the connection between a resource manager and a transaction manager in a distributed transaction processing environment. In one embodiment, a Java mapping of the industry standard XA interface may be implemented as an XAResource.

A transaction manager may also be implemented within an application server 600. A distributed state management adapter 602 and a distributed state management server 604 such as described above may also provide functionality to support global transactions. The distributed state management server may implement an XAResource interface, enabling it to participate in transactions controlled and coordinated by the transaction manager. For example, a transaction wrapper 603 of a distributed state management adapter 602 may receive transaction information from a transaction manager 601 and associate the transaction with data in a transaction resource 605 managed by a distributed state management server 604. The distributed state management adapter may maintain a 1-1 relationship between the connections and XAResource instances.

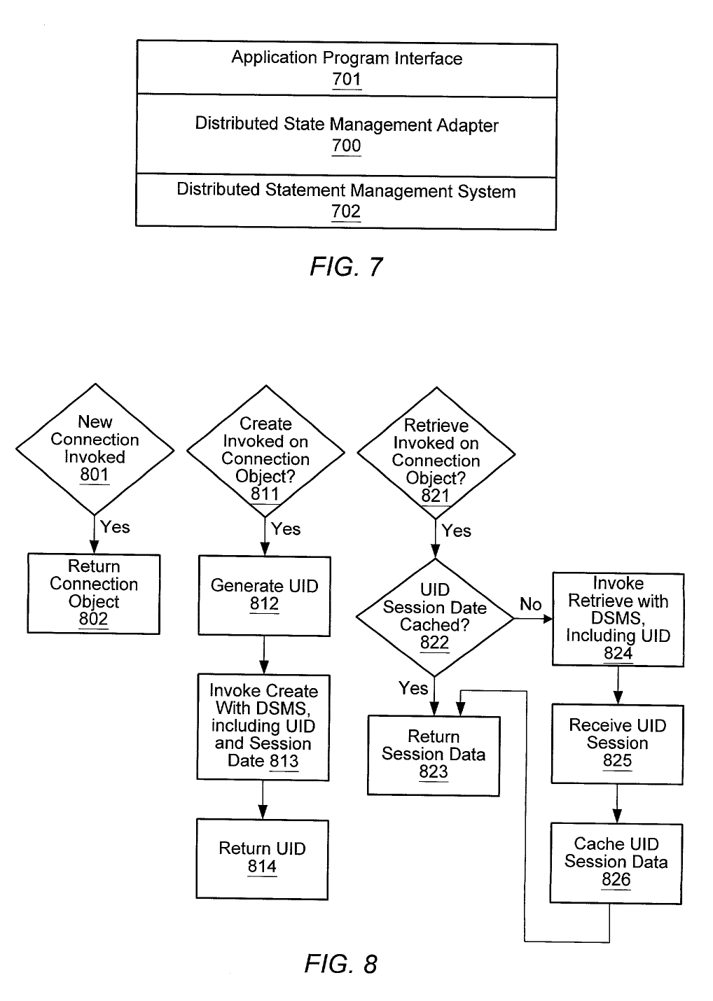

FIG. 7 illustrates a distributed state management adapter 700 that provides an interface between an application server and/or applications and a distributed state management server, such as the distributed state management adapters described above in conjunction with FIGS. 3-6. The distributed state management adapter may be coupled to an application or application server through application program interface 701. The application program interface 701 provides a standard interface for accessing distributed state management functions. The distributed state management adapter 700 may be coupled to a distributed state management server through a Adistributed state management server (DSMS) interface 702. The DSMS interface 702 provides an interface to a distributed state management server according to a standard service provider interface for distributed state management servers.

FIG. 8 presents flowcharts illustrating a distributed state management adapter responding to connection, create, and retrieve requests according to one embodiment. If the connection function is invoked by an application, as indicated at 801, the distributed state management adapter may create or initialize a new connection object or structure for handling communication with the application. The connection information or object is returned to the application, as indicated at 802.

An application (e.g. enterprise application component, application server, etc.) may invoke the create function to an established connection, as indicated at 811, and pass state data. A distributed state management adapter may generate a universal identifier corresponding to that data, as indicated at 812. The distributed state management adapter may cache the data. The distributed state management adapter may invoke a create function with a distributed state management server, transmitting the universal identification and state data, as indicated at 813. The distributed state management adapter may return the universal identification to the application, as indicated at 814.

An application may invoke the retrieve function to an established connection, as indicated at 821, and transmitted pass a universal identifier referencing the state data to be retrieved. A distributed state management adapter may determine if the requested data is cached, or available locally, as indicated at 822. If the requested data is cached, the distributed state management adapter may return the requested data to the application, as indicated at 823. If the requested data is not cached, the distributed state management adapter may invoke the retrieve function of a distributed state management server, as indicated at 824, transmitting the universal identifier. The distributed state management server may retrieve the identified data from wherever it is stored in the distributed system. The distributed state management adapter may receive the requested data corresponding to the universal identifier from the distributed state management server, as indicated at 825. The distributed state management adapter may cache the requested data received from the distributed state management server, as indicated at 826. The distributed state management adapter may then return the requested data to the requesting application, as indicated at 823.

Various embodiments may further include receiving, sending or storing instructions and/or data implemented in accordance with the foregoing description upon a carrier medium. Generally speaking, a carrier medium may include storage media or memory media such as magnetic or optical media, e.g., disk or CD-ROM, volatile or nonvolatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

What is claimed is:

1. A system, comprising:
a plurality of application servers each configured to access state data within a distributed system;
a plurality of distributed state management adapters, wherein each one of the distributed state management adapters is coupled through a standard application program interface to one of the plurality of application servers; and
a distributed state management server coupled to the plurality of distributed state management adapters through a standard service provider interface, wherein the distributed state management server is configured to manage storage and retrieval of state data within the distributed system;
wherein each distributed state management adapter is configured to communicate state data between its corresponding application server and the distributed state management server through its standard application program interface and the standard service provider interface for the distributed state management server.

2. The system as recited in claim 1, further comprising an application configured to operate within a container of one of the application servers, wherein the application is configured to create or access state data through one of the distributed state management adapters.

3. The system as recited in claim 2, wherein the application is configured to create or access state data through its distributed state management adapter according to the standard application program interface for the distributed state management adapter.

4. The system as recited in claim 2, wherein the application is configured to interact with its application server to create or access state data through the corresponding distributed state management adapter.

5. The system as recited in claim 2, wherein the application and the distributed state management adapter through which the application accesses state data within the distributed system, are configured to execute within the same virtual machine.

6. The system as recited in claim 1, wherein the distributed state management server is configured to execute within a separate virtual machine than each distributed state management adapter.

7. The system as recited in claim 1, wherein the plurality of application servers comprise a first application server and a second application server configured to access the same state data through their respective distributed state management adapters.

8. The system as recited in claim 7, wherein the first application server and the second application server are different types of application servers.

9. The system as recited in claim 1, wherein the distributed state management server is configured to replicate state data from a data store for a first one of the plurality of application servers to a data store for a second one of the plurality of application servers.

10. The system as recited in claim 9, wherein the state data comprises session data for a client session running on the first application server, wherein the second application server is configured to take over the client session if the first application fails using the state data replicated by the distributed state management server.

11. The system as recited in claim 1, wherein the distributed state management server is configured to access state data corresponding to a universal identifier in response to receiving a state data request including the universal identification number from one of the application servers through its distributed state management adapter.

12. The system as recited in claim 1, wherein the standard application program interface for the plurality of distributed state management adapters is configured to provide a standard interface for an application or application server to create new state data objects within the distributed system.

13. The system as recited in claim 1, wherein the standard application program interface for the plurality of distributed state management adapters is configured to provide a standard interface for synchronizing state data objects between application servers within the distributed system.

14. The system as recited in claim 1, wherein the standard application program interface for the plurality of distributed state management adapters is configured to provide a standard interface for an application or application server to retrieve state data objects within the distributed system.

15. The system as recited in claim 1, wherein the standard application program interface for the plurality of distributed state management adapters is configured to provide a standard interface for an application or application server to invalidate state data objects within the distributed system.

16. The system as recited in claim 1, wherein the standard application program interface for the plurality of distributed state management adapters is configured to provide a standard interface for handling transaction state data objects within the distributed system.

17. The system as recited in claim 1, wherein one or more of the distributed state management adapters is configured to cache state data accessed by the application server coupled to that distributed state management adapters.

18. The system as recited in claim 1, wherein the standard application program interface for the plurality of distributed state management adapters is configured to provide a standard interface for an application or application server to access distributed state management functions of the distributed state management server.

19. A carrier medium comprising program instructions executable to implement a distributed state management adapter, comprising:
a standard application program interface configured to be coupled to an application server, wherein the application server is configured to access state data through the standard application program interface; and
a standard distributed state management server interface configured to be coupled to a distributed state management server, wherein the distributed state management server is configured to manage storage and retrieval of state data;
wherein the distributed state management adapter is configured to communicate state data between the application server and the distributed state management server through the standard application program interface and the standard distributed state management server interface.

20. The carrier medium as recited in claim 19, wherein the standard application program interface is configured to be coupled to an application configured to create or access state data through the distributed state management adapter.

21. The carrier medium as recited in claim 20, wherein the distributed state management adapter is configured to provide an interface for the application to create or access state data through the application server.

22. The carrier medium as recited in claim 20, wherein the distributed state management adapter is configured to execute within the same virtual machine as the application.

23. The carrier medium as recited in claim 19, wherein the distributed state management adapter is configured to execute within a separate virtual machine than the distributed state management server.

24. The carrier medium as recited in claim 19, wherein the distributed state management adapter is configured to access state data corresponding to a universal identification number through the standard distributed state management server interface in response to receiving a state data request including the universal identification number from the application server through the application program interface.

25. The carrier medium as recited in claim 19, wherein the standard application program interface is configured to provide a standard interface for an application or application server to create new state data objects.

26. The carrier medium as recited in claim 19, wherein the standard application program interface is configured to provide a standard interface for an application or application server to synchronize state data objects.

27. The carrier medium as recited in claim 19, wherein the standard application program interface is configured to provide a standard interface for an application or application server to retrieve state data objects.

28. The carrier medium as recited in claim 19, wherein the standard application program interface is configured to provide a standard interface for an application or application server to invalidate state data objects.

29. The carrier medium as recited in claim 19, wherein the standard application program interface is configured to provide a standard interface for handling transaction state data objects.

30. The carrier medium as recited in claim 19, wherein the distributed state management adapter is configured to cache state data accessed by the application server.

31. The carrier medium as recited in claim 19, wherein the standard application program interface for the plurality of distributed state management adapters is configured to provide a standard interface for an application or application server to access distributed state management functions of the distributed state management server.

32. A method comprising:
a first application server sending state data to a first distributed state management adapter according to a standard application program interface;
the first distributed state management adapter sending the state data to a distributed state management server according to a service provider interface in response to receiving the state data;
the distributed state management server storing the state data in response to receiving the state data;
a second application server sending a state data request corresponding to the state data to a second distributed state management adapter according to a standard application program interface;
the second distributed state management adapter sending the state data request to the distributed state management server according to the service provider interface in response to receiving the state data request;
the distributed state management server sending the state data to the second distributed state management adapter according to the service provider interface in response to receiving the state data request; and
the second distributed state management adapter sending the state data to the second application server in response to receiving the state data.

33. The method as recited in claim 32, wherein the first application server and the second application server are different types of application servers.

34. The method as recited in claim 32, further comprising:
the first distributed state management adapter generating a universal identification number corresponding to the state in response to receiving the state data;
the first distributed state management adapter sending the universal identification number to the first application server and to the distributed state management server;
the second application server sending the universal identification number with the state data request to the second distributed state management adapter; and
the second distributed state management adapter sending the universal identification number with the state data request to the distributed state management server.

35. The method as recited in claim 32, further comprising:
the first distributed state management adapter registering with the distributed state management server; and
the second distributed state management adapter registering with the distributed state management server.

36. The method as recited in claim 32, wherein said distributed state management server storing the state data includes the distributed state management server sending the state data to a distributed data system.

37. The method as recited in claim 32, further comprising a distributed state management adapter generating the first distributed state management adapter in response to a request from the first application server.

38. The method as recited in claim 32, further comprising the second distributed state management adapter caching the state data.

39. The method as recited in claim 1, wherein the standard application program interface for the plurality of distributed state management adapters is configured to provide a standard interface for an application or application server to access distributed state management functions of the distributed state management server.
